(19) United States
(12) Patent Application Publication
(10) Pub. No.: US 2022/0231613 A1
(43) Pub. Date: Jul. 21, 2022

(54) POWER SUPPLY DEVICE AND VOLTAGE CONVERTING METHOD

(71) Applicant: CHICONY POWER TECHNOLOGY CO., LTD., NEW TAIPEI CITY (TW)

(72) Inventors: Yung Hung HSIAO, NEW TAIPEI CITY (TW); Chia Hsien YEN, NEW TAIPEI CITY (TW); Zih Yuan TONG, NEW TAIPEI CITY (TW); Hao Chieh CHANG, NEW TAIPEI CITY (TW); Cheng Chang HSIAO, NEW TAIPEI CITY (TW)

(21) Appl. No.: 17/394,019

(22) Filed: Aug. 4, 2021

(30) Foreign Application Priority Data
Jan. 20, 2021 (TW) 110102167

(51) Int. Cl. H02M 7/217; H02M 1/42

(52) U.S. Cl. CPC H02M 7/217; H02M 1/4208

(57) ABSTRACT

A power supply apparatus includes a full-wave rectifying circuit for converting an AC input voltage to a rectified voltage and a controller coupled to the full-wave rectifying circuit. The full-wave rectifying circuit includes a first switching circuit and a second switching circuit. During a general stage, the controller controls the first or second switching circuit to perform an active rectifying operation once an absolute value of the AC input voltage is greater than a lower bound voltage. During an initialization stage, the full-wave rectifying circuit performs a passive rectifying operation to convert the AC input voltage to the rectified voltage, and the controller controls the first or second switching circuit to switch from performing the passive rectifying operation to performing the active rectifying operation once the absolute value of the AC input voltage reaches or exceeds an upper bound voltage.

### PRIORITY CLAIM AND CROSS-REFERENCE

This application claims priority of Taiwan application No. 110102167, filed on Jan. 20, 2021, which is incorporated by reference in its entirety.

### TECHNICAL FIELD

The present disclosure relates to a power supply apparatus and a voltage converting method, and more particularly, to a power conversion apparatus for converting an alternating current (AC) voltage to a direct current (DC) voltage and a method of converting the AC input voltage to the DC voltage.

### DISCUSSION OF THE BACKGROUND

Electronic products are generally equipped with a power supply to convert an alternating current (AC) power provided from a wall outlet into DC power. The power supply is often equipped with rectifiers that convert the AC power to a pulsating DC power. The conventional rectifier mainly uses diodes, having one-way conduction characteristic, to convert the AC power, whose level and polarity change periodically, into the pulsating DC voltage, whose level changes regularly over time but its polarity remains unchanged. However, when the power supply operates in a medium power mode or a high power mode, the varying magnitudes of the input current would cause unstable efficiency of the power supply due to the characteristics of the diodes.

This Discussion of the Background section is provided for background information only. The statements in this Discussion of the Background are not an admission that the subject matter disclosed in this Discussion of the Background section constitute prior art to the present disclosure, and no part of this Discussion of the Background section may be used as an admission that any part of this application, including this Discussion of the Background section, constitutes prior art to the present disclosure.

### SUMMARY

The present disclosure provides a power supply apparatus and a voltage converting method to reduce power loss of a rectifying circuit in the power supply apparatus as it is operated in a high current input environment.

One aspect of the present disclosure provides a power supply apparatus. The power supply apparatus, for operating in an initialization stage and a general stage, includes a full-wave rectifying circuit and a controller. The full-wave rectifying circuit comprises a first switching circuit and a second switching circuit, wherein the full-wave rectifying circuit receives an alternating current (AC) voltage through a live line and a neutral line and is configured to convert the AC input voltage to a rectified voltage. The controller is coupled to the full-wave rectifying circuit and configured to control the first switching circuit or the second switching circuit to perform an active rectifying operation as an absolute value of the AC input voltage is greater than a lower bound voltage during the general stage, wherein during the initialization stage, the full-wave rectifying circuit performs a passive rectifying operation for at least a first half-cycle of the AC input voltage, and the controller is configured to control the first switching circuit or the second switching circuit to switch from performing the passive rectifying operation to performing the active rectifying operation as the absolute value of the AC input voltage upwardly reaches or exceeds an upper bound voltage, wherein the upper bound voltage is greater than the lower bound voltage.

Another aspect of the present disclosure provides a power supply apparatus. The power supply apparatus, for operating in an initialization stage and a general stage, includes a full-wave rectifying circuit and a controller. The full-wave rectifying circuit comprises a first switching circuit and a second switching circuit, wherein the full-wave rectifying circuit receives an AC input voltage through a live line and a neutral line, and is configured to convert the AC input voltage to a rectified voltage. The controller is coupled to the full-wave rectifying circuit, and configured to control the first switching circuit or the second switching circuit to perform an active rectifying operation during the general stage, wherein during the initialization stage, the full-wave rectifying circuit performs a passive rectifying operation for at least one half-cycle of the AC input voltage, the controller is configured to control the first switching circuit or the second switching circuit to switch from performing the passive rectifying operation to performing the active rectifying operation as the AC input voltage approaches a first preset phase, the AC input voltage has a sinusoidal waveform, and the first preset phase is represented by:

$$( \frac{1}{2} + m ) π ,$$

where m is an integer.

Another aspect of the present disclosure provides a voltage converting method. The voltage converting method comprises performing, by a full-wave rectifying circuit, a passive rectifying operation to an AC input voltage for at least one half-cycle of the AC input voltage to generate a rectified voltage, and controlling the full-wave rectifying circuit to enter an active rectifying operation from the passive rectifying operation when an absolute value of the AC input voltage reaches or exceeds an upper bound voltage upwardly.

Another aspect of the present disclosure provides a voltage converting method. The voltage converting method comprises performing, by a full-wave rectifying circuit, a passive rectifying operation to an AC input voltage for at least one half-cycle of the AC input voltage to generate a rectified voltage, and controlling the full-wave rectifying circuit to enter an active rectifying operation from the passive rectifying operation as the AC input voltage approaches a first preset phase, wherein the AC input voltage has a sinusoidal waveform, and the first preset phase is represented by:

$$( \frac{1}{2} + m ) π ,$$

where m is an integer.

The foregoing has outlined rather broadly the features and technical advantages of the present disclosure in order that the detailed description of the disclosure that follows may be better understood. Additional features and technical advantages of the disclosure are described hereinafter, and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be coupled to the figures' reference numbers, which refer to similar elements throughout the description.

FIG. 1 is a circuit block diagram of a power supply apparatus in accordance with some embodiments of the present disclosure.

FIG. 2 is a circuit block diagram of power conversion module in accordance with some embodiments of the present disclosure.

FIG. 3 depicts an exemplary waveform diagram of an alternating current (AC) input voltage applied to the power supply apparatus, an absolute value of the AC input voltage, an input current, a rectified voltage, a direct current (DC) central voltage, and electrical signals in accordance with some embodiments of the present disclosure.

FIG. 4 depicts the relationship between the forward voltage and the forward current of a diode in accordance with some embodiments of the present disclosure.

FIG. 5 depicts the relationship between the forward voltage and the forward current of the semiconductor switch in accordance with some embodiments of the present disclosure.

FIG. 6 is a circuit block diagram of a power conversion module in accordance with some embodiments of the present disclosure.

FIG. 7 depicts an exemplary waveform diagram of an AC input voltage applied to the power supply apparatus, an absolute value of the AC input voltage, an input current, a rectified voltage, a DC central voltage, and electrical signals in accordance with some embodiments of the present disclosure.

FIG. 8 is a circuit block diagram of a power supply apparatus in accordance with some embodiments of the present disclosure.

FIG. 9 is a circuit block diagram of power conversion module in accordance with some embodiments of the present disclosure.

FIG. 10 depicts an exemplary waveform diagram of an AC input voltage applied to the power supply apparatus, an absolute value of the AC input voltage, an input current, a rectified voltage, a DC central voltage, and electrical signals in accordance with some embodiments of the present disclosure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. It will be understood that when an element is referred to as being “connected to” or “coupled to” another element, it may be directly connected to or coupled to the other element, or intervening elements may be present.

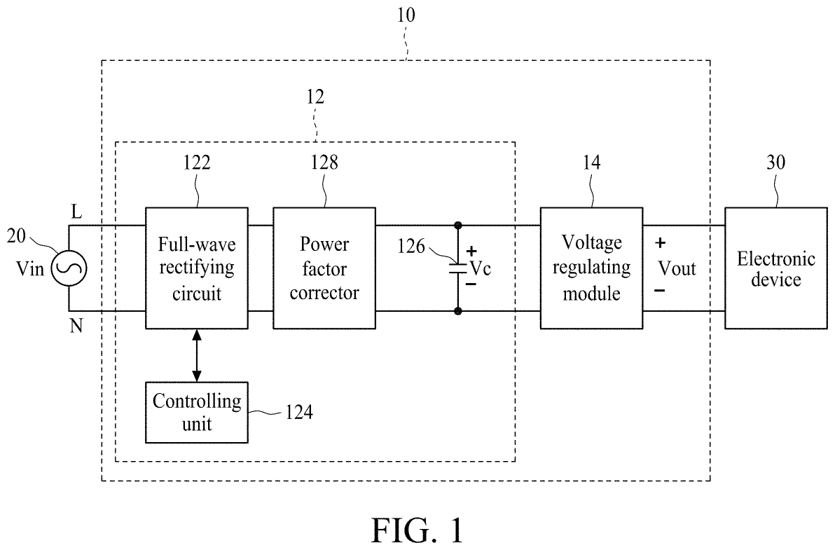

FIG. 1 is a circuit block diagram of a power supply apparatus in accordance with some embodiments of the present disclosure. Referring to FIG. 1, the power supply apparatus 10 can receive an alternating current (AC) input voltage Vin from an external source 20 (such as a wall outlet) and convert the AC input voltage Vin into a direct current (DC) output voltage Vout of a certain level for powering an electronic device 30. In the present disclosure, the AC input voltage Vin is an electrical signal which continuously alternates polarity and changes magnitude with time, and more particularly, an electrical signal which reverses polarity and changes magnitude periodically with its average amplitude being zero. The DC output voltage Vout is an electrical signal with non-varying polarity and stable magnitude. The electronic device 30 may be a server, a working station, a (backup) battery unit, a storage system or other electronic products requiring high efficiency and high-power output. The power supply apparatus 10 may be installed in the electronic device 30. Alternatively, the power supply apparatus 10 can be disposed separately and independently from the electronic device 30, and the power supply apparatus 10 can be electrically coupled to the electronic device 30 through a cable (not shown). In some embodiments, the power supply apparatus 10 is coupled to the external source 20 by using a detachable plug.

The power supply apparatus 10 includes a power conversion module 12 and a voltage regulating module 14. The power conversion module 12 is coupled to the external source 20 through a live line L and a neutral line N. The power conversion module 12 receives the AC input voltage Vin from the external source 20 and is configured to convert the AC input voltage Vin to a DC central voltage Vc. The voltage regulating module 14 is electrically coupled to the power conversion module 12 and configured to regulate the magnitude of the DC central voltage Vc so as to generate the DC output voltage Vout of a certain level. In some embodiments, the voltage regulating module 14 may be achieved by using switched buck or boost converter. In the less stringent applications, the voltage regulating module 14 may be a linear regulator. In some embodiments, the power regulating module 14 can be a non-isolated DC to DC power converter or an isolated DC to DC power converter. The non-isolated DC to DC power converter has advantages of being high efficient, compact, and cost effective. The isolated DC to DC power converter usually employs a transformer for isolating the DC central voltage Vc and the DC output voltage Vout, thereby improving the safety of electricity usage.

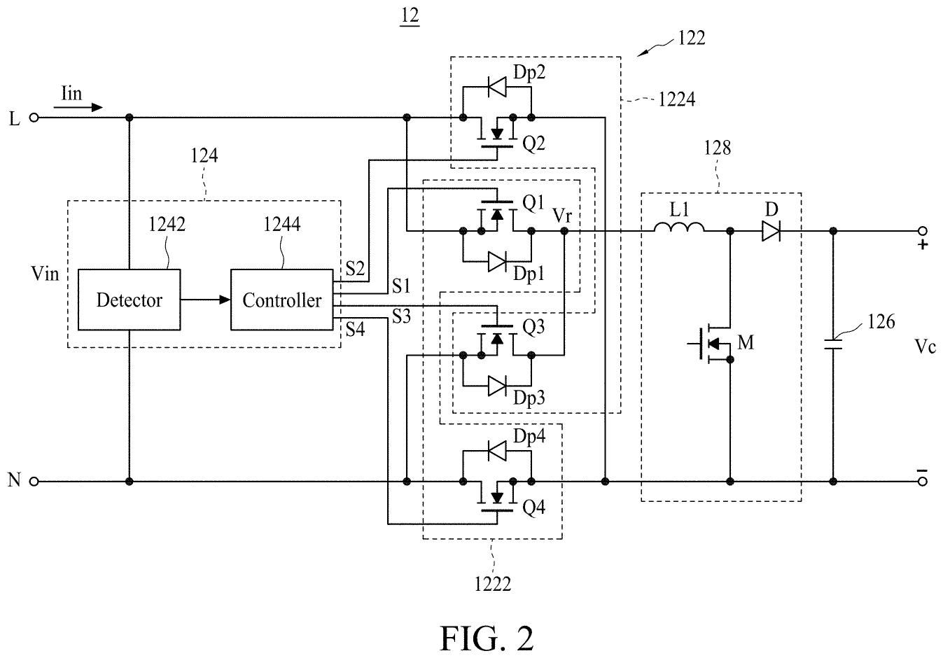

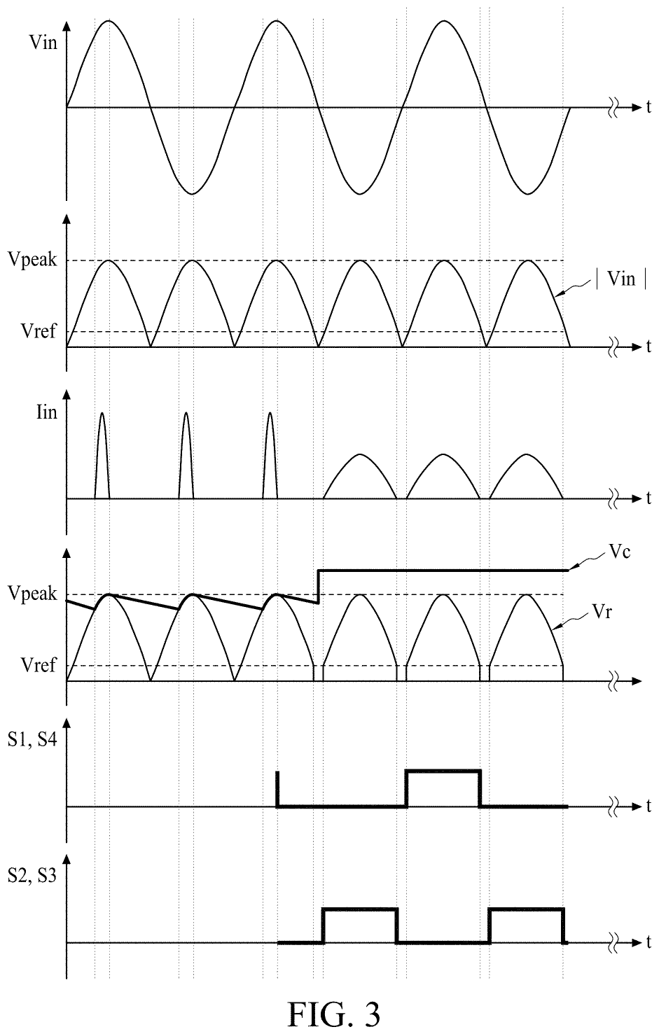

FIG. 2 is a circuit block diagram of the power conversion module in accordance with some embodiments of the present disclosure. Referring to FIGS. 1 and 2, the power conversion module 12 includes a full-wave rectifying circuit 122, a controlling unit 124 and a bulk capacitor 126. The full-wave rectifying circuit 122 is arranged between the external source 20 and the bulk capacitor 126, and adapted to perform a passive rectifying operation or an active rectifying operation for converting the AC input voltage Vin to a rectified voltage Vr. The rectified voltage Vr is a pulse DC voltage having a non-varying polarity and with magnitude varying with time, as shown in FIG. 3.

Referring again to FIG. 2, the full-wave rectifying circuit 122 includes a first switch Q1, a second switch Q2, a third switch Q3, and a fourth switch Q4. The switches Q1 to Q4 can be metal-oxide-semiconductor field-effect transistors (MOSFETs), junction field-effect transistors (JFETs) or other transistors or semiconductor switches that can switch the electrical signal. In the present disclosure, the switches Q1 to Q4 are N-type enhancement MOSFETs.

In FIG. 2, the source of the first switch Q1 and the drain of the second switch Q2 are electrically coupled to the live line L, the source of the third switch Q3 and the drain of the fourth switch Q4 are electrically coupled to the neutral line N, the drain of the first switch Q1 is electrically coupled to the drain of the third switch Q3, and the source of the second switch Q2 is electrically coupled to the source of the fourth switch Q4. The first switch Q1 and the fourth switch Q4 constitute a first switching circuit 1222, and the second switch Q2 and the third switch Q3 constitute a second switching circuit 1224. The gates of the switches Q1 to Q4 are electrically coupled to the controlling unit 124 separately, and the switches Q1 to Q4 can be turned on or turned off according to the received electrical signals generated by the controlling unit 124 respectively, thereby achieving the function of active rectification. In the present disclosure, the switches Q1 to Q4 can be turned on as the electrical signal conducted thereto is in a logic high level and can be turned off as the electrical signal conducted thereto is in a logic low level.

The first switch Q1 may have a parasitic diode Dp1; the anode of the parasitic diode Dp1 is electrically coupled to the source of the first switch Q1, and the cathode thereof is electrically coupled to the drain of the first switch Q1. Similarly, the second switch Q2 may have a parasitic diode Dp2, the third switch Q3 may have a parasitic diode Dp3, and the fourth switch Q4 may have a parasitic diode Dp4. The anodes of the parasitic diodes Dp2 to Dp4 are electrically coupled to the respective sources of the switches Q2 to Q4, and the cathodes of the parasitic diodes Dp2 to Dp4 are electrically coupled to the respective drains of the switches Q2 to Q4. The parasitic diodes Dp1 to Dp4 are mainly employed to perform the passive rectifying operation. For example, after the power supply apparatus 10 is activated, the parasitic diodes Dp1 to Dp4 can convert the AC input voltage Vin to the rectified voltage Vr before the controlling unit 124 starts to provide the electrical signals to the switches Q1 to Q4. In some embodiments, the AC input voltage Vin can have a sinusoid waveform (as shown in FIG. 3), and the parasitic diodes Dp1 to Dp4 can be employed to covert the negative voltage to the positive voltage, thereby generating the pulse DC voltage. As can be seen in FIG. 3, the frequency of the rectified voltage Vr is twice the frequency of the AC input voltage Vin. The rectified voltage Vr outputted from the full-wave rectifying circuit 122 is conducted to the bulk capacitor 126; the bulk capacitor 126 can be charged and discharged accordingly to smooth the rectified voltage Vr, thereby outputting the DC central voltage Vc.

Referring again to FIGS. 1 and 2, the power supply apparatus 10 further includes a power factor corrector 128 arranged between the full-wave rectifying circuit 122 and the bulk capacitor 126. The power factor corrector 128 is used to eliminate or reduce the phase difference between the rectified voltage Vr and the current created accordingly (i.e., the current is in-phase with the rectified voltage Vr), thereby improving power efficiency. In the present disclosure, the power factor corrector 128 is an active power factor corrector that can step up the rectified voltage Vr. In FIG. 2, the power factor corrector 128 includes a power switch M, an inductor L1 and a diode D; one terminal of the inductor L1 is electrically coupled to the first switch Q1 and the third switch Q3 of the full-wave rectifying circuit 122, and the other terminal of the inductor L1 is electrically coupled to the anode of the diode D. The power switch M is an N-type enhancement MOSFETs; the drain of the power switch M is electrically coupled to the anode of the diode D, and the source of the power switch M is electrically coupled to the sources of the second switch Q2 and the fourth switch Q4 in the full-wave rectifying circuit 122. One terminal of the bulk capacitor 126 is electrically coupled to the cathodes of the diode D, and the other terminal there of the bulk capacitor 126 is electrically coupled to the source of the power switch M. The power switch M can be switched between a conductive state and a nonconductive state in accordance with a pulse-width modulation (PWM) signal conducted to its gate, thereby controlling the current that flows through the inductor L1 and improving the function of power factor correction.

The power supply apparatus 10 is operable in a general phase and an initialization phase. The power supply apparatus 10 is operated in the initialization phase first when it is activated from an inactive state. After the initialization phase is completed, the power supply apparatus 10 would enter the general phase, in which an active-rectifying operation and a power factor correction operation are performed. That is, the phase in which the power supply apparatus 10 is in an active state and the power factor corrector 128 can successfully perform the power factor correction function is called the general phase, while the phase in which the power supply apparatus 10 is in the active state and the power factor corrector 128 has not been ready to perform the function of power factor correction is called the initialization phase. Ideally, when the power supply apparatus 10 is activated, the full-wave rectifying circuit 122 and the controlling unit 124 would perform the operation of rectification to convert the AC input voltage Vin to the rectified voltage Vr concurrently. Further, in the ideal case, when the power supply apparatus 10 is activated, the power factor corrector 128 would concurrently be ready to perform the function of power factor correction. However, transmission delays of the electrical signals may occur in the power supply apparatus 10 due to the limitations of electronic components characteristics in the power supply apparatus 10 and the undesirable factors (such as parasitic capacitance) caused by the interactions among the electronic components. Therefore, it would take some time after the power supply apparatus 10 is activated before the controlling unit 124 becomes stabilized and gets ready to generate the electrical signals (denoted by S1, S2, S3 and S4 in FIG. 3) for controlling the first switching circuit 1222 and the second switching circuit 1224. In some embodiments, the time required by the controlling unit 124 to get ready for generating the electrical signals after the power supply apparatus 10 is activated is called a response time. Similarly, after the power supply apparatus 10 is activated from the inactive state, the power factor corrector 128 would require a predetermined response time before it is ready to perform the power factor correction operation. In the present disclosure, the initialization phase refers to the time period after the AC input voltage Vin enters the power supply apparatus 10 and before the power factor corrector 128 starts to perform the power factor correction operation. In the initialization phase, the full-wave rectifying circuit 122 can perform the passive rectifying operation, and can switch from the passive rectifying operation to the active rectifying operation.

Referring to FIGS. 2 and 3, when the power supply apparatus 10 is activated and operates in the initialization phase, the parasitic diodes Dp1 to Dp4 in the full-wave rectifying circuit 122 are capable of performing the passive rectifying operation in accordance with the magnitude of the AC input voltage Vin. Typically, the parasitic diodes Dp1 to Dp4 has a characteristic of one-way conduction. Therefore, when a voltage applied to the two terminals of each parasitic diode Dp1 to Dp4 is equal to or greater than a threshold voltage, the AC input voltage Vin would be conducted from the anode of the respective parasitic diode Dp1 to Dp4 to the cathode thereof. On the contrary, when the voltage across each parasitic diode Dp1 to Dp4 is smaller than the threshold voltage, the AC input voltage Vin cannot be conducted from its anode to the cathode.

Accordingly, in FIG. 2, the parasitic diodes Dp1 and Dp4 in the full-wave rectifying circuit 122 are switched on at the positive half-cycles of the AC input voltage Vin, and the parasitic diodes Dp2 and Dp3 in the full-wave rectifying circuit 122 are switched on at the negative half-cycles of the AC input voltage Vin. The parasitic diodes Dp1 to Dp4 of the full-wave rectifying circuit 122 can perform the passive rectifying operation to the AC input voltage Vin for at least a first half-cycle of the AC input voltage Vin to generate the rectified voltage Vr. For example, in FIG. 3, the full-wave rectifying circuit 122 performs the passive rectifying operation at the first and second half-cycle of the AC input voltage Vin. The amount of the half-cycles of the AC input voltage Vin that the full-wave rectifying circuit 122 performs the passive rectifying operation is determined by the response time of the controlling unit 124.

After the power supply apparatus 10 is switched from the inactive state to the active state and after the response time of the controlling unit 124 has elapsed, the controlling unit 124 begins to control the first switching circuit 1222 or the second switching circuit 1224 to switch from performing the passive rectifying operation to performing the active rectifying operation once an absolute value of the AC input voltage Vin (denoted by |Vin| in FIG. 3) reaches or exceeds an upper bound voltage Vpeak upwardly. In the present disclosure, the controller 1244 is configured to control the first switching circuit 1222 to switch from performing the passive rectifying operation to performing the active rectifying operation when the absolute value of the AC input voltage Vin in the positive half-cycle reaches or exceeds the upper bound voltage Vpeak, and is configured to control the second switching circuit 1224 to switch from performing the passive rectifying operation to performing the active rectifying operation when the absolute value of the AC input voltage Vin in the negative half-cycle reaches or exceeds the upper bound voltage Vpeak. Due to the differences of the component specifications and the circuitry topologies, the controlling units 124 in different power supply apparatus 10 may have different response times. For example, in FIG. 3, when the power supply apparatus 10 is activated, the AC input voltage Vin has a sinusoidal waveform and the phase angle of the AC input voltage Vin is zero, in such case, when entering the third half-cycle of the AC input voltage Vin, the detector 1242 will detect that the absolute value of the AC input voltage Vin has reached or exceeded the upper bound voltage Vpeak, so the controlling unit 124 would generate the electrical signals S1 and S4 with the logic high level to the first switch Q1 and the fourth switch Q4 in accordance with the instantaneous level of the absolute value of the AC input voltage Vin, so as to control the first switching circuit 1222 to switch from performing the passive rectifying operation to performing the active rectifying operation. In the present embodiment, the first switch Q1 is turned on or off based on the logic level of the electrical signal S1, and the fourth switch Q4 is turned on or off based on the level of the electrical signal S4.

In order to effectively determine whether the absolute value of the AC input voltage Vin has reached or exceeded the upper bound voltage Vpeak, the controlling unit 124 may include a detector 1242 for monitoring the instantaneous level of the AC input voltage Vin. The controlling unit 124 further includes a controller 1244 electrically coupled to the detector 1242; the controller 1244 generates the electrical signals S1 to S4 to turn on or turn off the switches Q1 to Q4 based on the comparison between the monitoring result of the detector 1242 and the upper bound voltage Vpeak.

In some embodiments, the upper bound voltage Vpeak can be a constant value. For example, the upper bound voltage Vpeak is a peak voltage of the rectified voltage Vr. In such embodiments, the upper bound voltage Vpeak may be written to (the firmware of) the controller 1244 in advance. When the controller 1224 determines whether to actuate the first switching circuit 1222 or the second switching circuit 1224, the monitoring result provided by the detector 1242 is compared with the upper bound voltage Vpeak stored within the controller 1224, and the electrical signals S1 to S4 for controlling the switches Q1 to Q4 is generated accordingly.

In the present disclosure, due to the differences of the component specifications and the circuitry topologies, the power factor correctors 128 in different power supply apparatus 10 may have different startup times. For convenience of explanation, in the present disclosure, the power supply apparatus 10 can be operated in the general phase after the full-wave rectifying circuit 122 is switched to performing the active rectifying operation from performing the passive rectifying operation for a half-cycle of the AC input voltage Vin (i.e., the fourth half-cycle of the AC input voltage Vin). Referring to FIG. 3, in the first to third half-cycles of the AC input voltage Vin, the function of power factor correction has not been yet carried out by the power factor corrector 128; therefore, the input current Iin and the AC input voltage Vin are out of phase with each other. In the fourth half-cycle of the AC input voltage Vin, power factor corrector 128 can carry out the power factor correction function, so the input current Iin and the AC input voltage Vin can have the synchronous phase. Secondly, since the power factor corrector 128 shown in FIG. 2 of the present disclosure is a step-up power factor corrector, the level of the DC intermediate voltage Vc can be increased when the power factor corrector 128 performs the power factor correction operation.

In the general phase, the controlling unit 124 is configured to control the first switching circuit 1222 or the second switching circuit 1224 to perform the active rectifying operation when the absolute value of the AC input voltage Vin is greater than a lower bound voltage Vref. Specifically, at the positive half-cycles of the AC input voltage Vin, the controlling unit 124 can generate the electrical signals S1 and S4 with the logic high level (as shown in FIG. 3) to the first switch Q1 and the fourth switch Q4 for turning on the first switch Q1 and the fourth switch Q4. The controlling unit 124 further generates the electrical signals S2 and S3 with the logic low level to the second switch Q2 and the third switch Q3 for turning off the second switch Q2 and the third switch Q3. At the negative half-cycles of the AC input voltage Vin, the controlling unit 124 can generate the electrical signals S1 and S4 with the logic low level (as shown in FIG. 3) to the first switch Q1 and the fourth switch Q4 for turning off the first switch Q1 and the fourth switch Q4. The controlling unit 124 can concurrently generate the electrical signals S2 and S3 with the logic high level to the second switch Q2 and the third switch Q3 for turning on the second switch Q2 and the third switch Q3.

The controlling unit 124 is further configured to control the first switching circuit 1222 or the second switching circuit 1224 to stop performing the active rectifying operation so as to stop converting the AC input voltage Vin to the rectified voltage Vr when the absolute value of the AC input voltage Vin is less than or equal to the lower bound voltage Vref. The lower bound voltage Vref is employed to avoid the switches Q1 to Q4 from concurrently turning on, which may cause the issue of short through.

It should be noted that when the power supply apparatus 10 is operated in the general phase, if the drain-source voltages of the first switch Q1 and the fourth switch Q4 in the actuated first switching circuit 1222 are equal to or greater than the threshold voltages of the respective parasitic diodes Dp1 and Dp4, the first switch Q1, the fourth switch Q4, and the parasitic diodes Dp1 and Dp4 would be turned on simultaneously. Similarly, when the power supply apparatus 10 is operated in the general phase, if the drain-source voltages of the second switch Q2 and the third switch Q3 in the actuated second switching circuit 1224 are equal to or greater than the threshold voltages of the respective parasitic diodes Dp2 and Dp3, the second switch Q2, the third switch Q3, and the parasitic diodes Dp2 and Dp3 would be turned on simultaneously. Consequently, at the positive half-cycles of the AC input voltage Vin, the input current Tin is divided into a switch current, which flows through the first switch Q1 and the fourth switch Q4 to the power factor corrector 128, and a diode current, which flows through the parasitic diodes Dp1 and Dp4 to the power factor corrector 128.

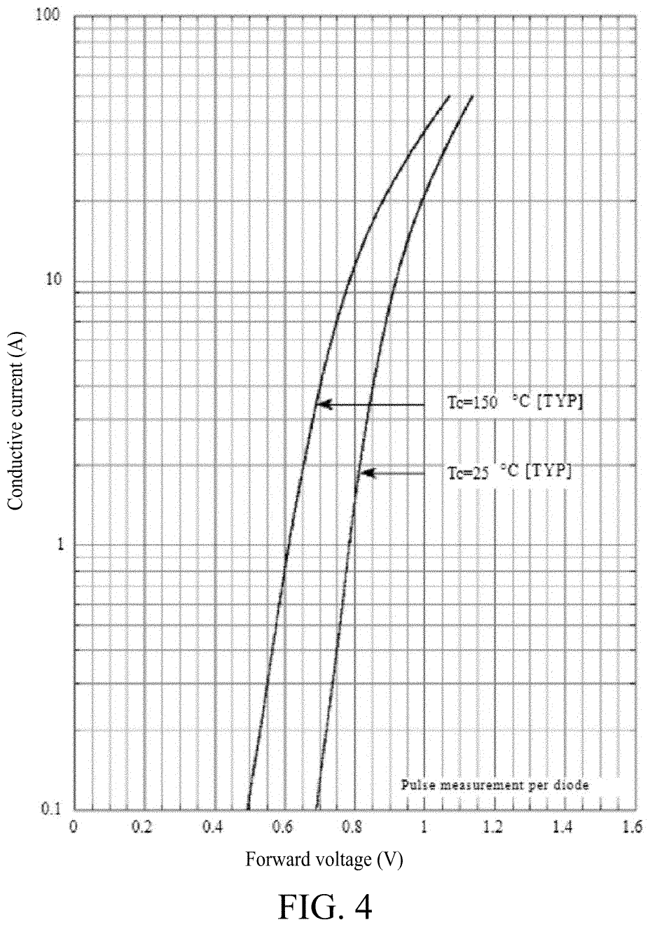

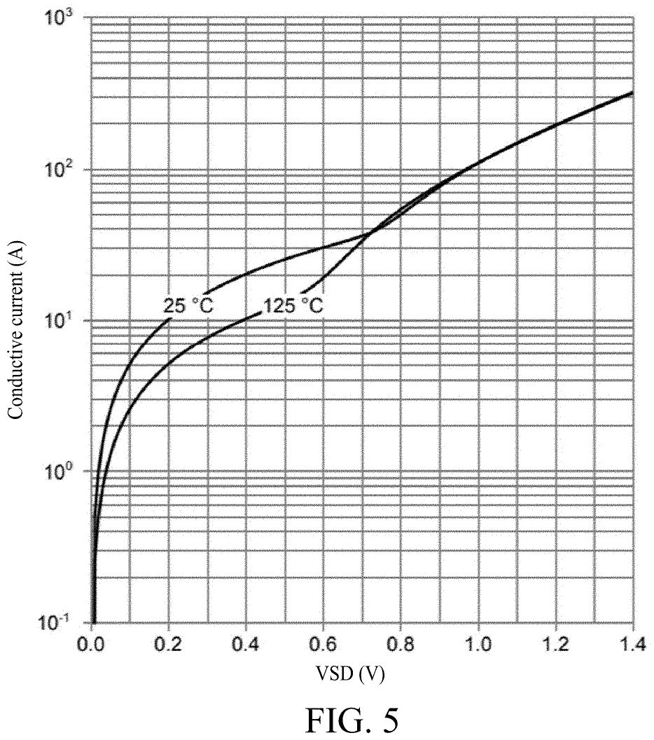

FIG. 4 shows a relationship between the forward voltage and the forward current of a diode, and FIG. 5 shows a relationship between the forward voltage and the forward current of the semiconductor switch. Referring to FIGS. 4 and 5, when the ambient temperature is 25° C. and the forward voltage is 0.8 volts, the forward current of the semiconductor switch is about 50 amperes, and the forward current of the diode is about 1.7 amperes. In a high-temperature environment (such as when the ambient temperature is greater than 120° C.) with the forward voltage being 1 volt, the forward current of the semiconductor switch is about 102 amperes, and the forward current of the diode is about 37 amperes. If the parasitic diodes Dp1 to Dp4 of the full-wave rectifying circuit 122 shown in FIG. 2 have the same characteristic shown in FIG. 4 and the switches Q1 to Q4 in the full-wave rectifying circuit 122 have the same characteristic shown in FIG. 5, the switch current would be about 96.7% of the input current Iin, and the diode current would be about 3.3% of the input current Iin when the power supply apparatus 10 is operated under a low temperature environment (for example, when the ambient temperature is 25° C.). In addition, when the power supply apparatus 10 is operated under a high temperature environment, the switch current would be about 73.4% of the input current Iin, and the diode current would be about 26.6% of the input current Iin. Typically, the conduction power loss of the parasitic diodes Dp1 to Dp4 is equal to the product of its forward voltage and the diode current, and the conduction power loss of the switches Q1 to Q4 is equal to the production of the square of the switch current and its conduction impedance. Therefore, in a low temperature environment, a percentage of the power conduction loss of the switches Q1 to Q4 is much smaller than a percentage of the power loss of the parasitic diodes Dp1 to Dp4. However, as the operation temperature of the power supply apparatus 10 increases with the increasing input current Iin, the percentage of power conduction loss of the switches Q1 to Q4 increases, while the percentage of power conduction loss of the parasitic diodes Dp1 to Dp4 decreases due to the forward voltage of the parasitic diodes Dp1 to Dp4 have a negative temperature coefficient. Notably, even if the percentage of power conduction loss of the parasitic diodes Dp1 to Dp4 decreases when the operation temperature raises it is still greater than the percentage of power conduction loss of the switches Q1 to Q4. Therefore, the function of active rectification carried out by the full-wave rectifying circuit 122, including the semiconductor switches and the diodes, can prevent the power loss from increasing drastically when the power supply apparatus 10 is in a high power mode.

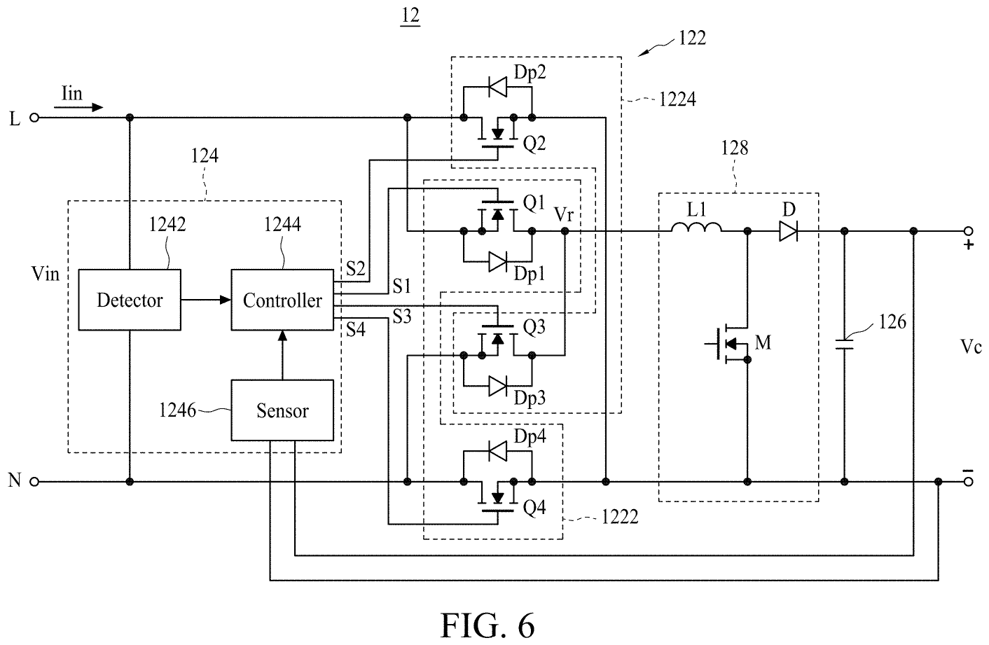

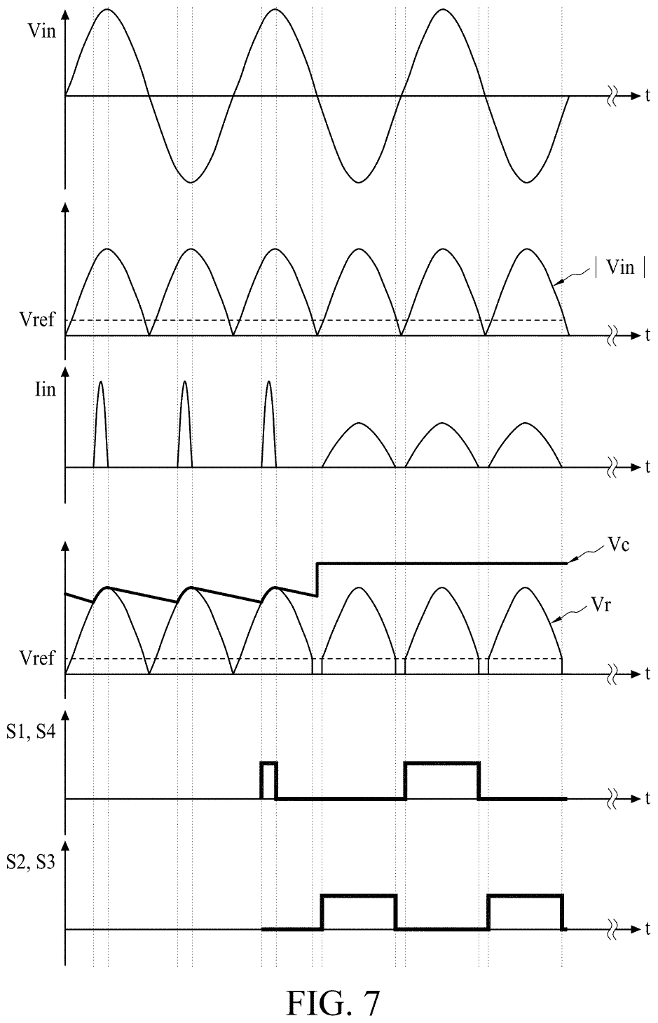

FIG. 6 is a circuit block diagram of a power conversion module in accordance with some embodiments of the present disclosure. Referring to FIG. 6, the power conversion module 12 is coupled to the external source (not shown) through a live line L and a neutral line N. The power conversion module 12 receives the AC input voltage Vin provided by the external source and is configured to convert the AC input voltage Vin to a DC central voltage Vc. The power conversion module 12 includes a full-wave rectifying circuit 122, a controlling unit 124, a bulk capacitor 126 and a power factor corrector 128. The full-wave rectifying circuit 122 is adapted to perform a passive rectifying operation or an active rectifying operation for converting the AC input voltage Vin to a rectified voltage Vr, wherein the rectified voltage Vr is a pulse DC voltage which has its magnitude changed with time and has a non-varying polarity, as shown in FIG. 7.

The full-wave rectifying circuit 122 includes a first switch Q1, a second switch Q2, a third switch Q3, and a fourth switch Q4. The first switch Q1 and the second switch Q2 are electrically coupled to the live line L, and the third switch Q3 is electrically coupled to the first switch Q1 and the neutral line N. The fourth switch Q4 is electrically coupled to the second switch Q2, the third switch Q3, and the neutral line N. The first switch Q1 and the fourth switch Q4 constitute a first switching circuit 1222, and the second switch Q2 and the third switch Q3 constitute a second switching circuit 1224. The switches Q1 to Q4 are electrically coupled to the controlling unit 124 respectively. The switches Q1 to Q4 are the N-type enhancement MOSFETs. The first switch Q1 may have a parasitic diode Dp1; the anode of the parasitic diode Dp1 is electrically coupled to the source of the first switch Q1, and the cathode thereof is electrically coupled to the drain of the first switch Q1. The second switch Q2 may have a parasitic diode Dp2, the third switch Q3 may have a parasitic diode Dp3, and the fourth switch Q4 may have a parasitic diode Dp4. The anodes of the parasitic diodes Dp2 to Dp4 are electrically coupled to the respective sources of the switches Q2 to Q4, and the cathodes of the parasitic diodes Dp2 to Dp4 are electrically coupled to the respective drains of the switches Q2 to Q4. The power factor corrector 128 is arranged between the full-wave rectifying circuit 122 and the bulk capacitor 126, and employed to eliminate or reduce the phase difference between the rectified voltage Vr and the current created accordingly, thereby improving the power efficiency. The power factor corrector 128 shown in FIGS. 2 and 6 may have identical topologies; therefore, the detailed description of the power factor corrector 128 in FIG. 6 is omitted. The bulk capacitor 126 is employed to be alternatively charged and discharged accordingly to smooth the rectified voltage Vr adjusted by the power factor corrector 128, thereby outputting the DC central voltage Vc.

The power supply apparatus 10 is operable in a general phase and an initialization phase. In the present embodiment, the phase in which the power supply apparatus 10 is in an active state and the power factor corrector 128 can successfully carry out the power factor correction function can be called the general phase, while the phase in which the power supply apparatus 10 is in the active state and the function of power factor correction has not been yet carried out by the power factor corrector 128 can be called the initialization phase. In the initialization phase, the parasitic diodes Dp1 to Dp4 in the full-wave rectifying circuit 122 are capable of performing the passive rectifying operation to convert the AC input voltage Vin to the rectified voltage Vr before the controlling unit 124 provides the electrical signals S1 to S4 to the switches Q1 to Q4.

After the power supply apparatus 10 changes from the inactive state to the active state and the response time of the controlling unit 124 has elapsed, the controlling unit 124 controls the first switching circuit 1222 or the second switching circuit 1224 to switch from performing the passive rectifying operation to performing the active rectifying operation when an absolute value of the AC input voltage Vin is equal to the DC central voltage Vc. In order to effectively determine whether the absolute value of the AC input voltage Vin is equal to the DC central voltage Vc, the controlling unit 124 may include the detector 1242, a controller 1244 and a sensor 1246; the detector 1242 is employed to monitor the instantaneous level of the AC input voltage Vin, the controller 1244 is electrically coupled to the detector 1242, and the sensor 1246 is adapted to monitor the instantaneous level of the DC central voltage Vc. The controller 1244 generates the electrical signals S1 to S4 for switching the switches Q1 to Q4 between on state and off state based on the monitoring results provided by the detector 1242 and the sensor 1246, so that the full-wave rectifying circuit 122 can be switched from performing the passive rectifying operation to performing the active rectifying operation.

For example, in FIG. 7, the full-wave rectifying circuit 122 performs the passive rectifying operation at the first and second half-cycles of the AC input voltage Vin, and starts performing the active rectifying operation from performing the passive rectifying operation at the third half-cycle of the AC input voltage Vin. Therefore, when the absolute value of the AC input voltage Vin is equal to the DC central voltage Vc, the controller 1244 is configured to generate the electrical signals S1 and S4 with the logic high level to the first switch Q1 and the fourth switch Q4, and generate the electrical signals S2 and S3 with the logic low level to the second switch Q2 and the third switch Q3.

During the general stage, the controlling unit 124 is configured to generate the electrical signals S1 and S4 with the logic high level to the first switching circuit 1222 or to generate the electrical signals S2 and S3 with the logic high level to second switching circuit 1224 for performing the active rectifying operation when the absolute value of the AC input voltage Vin becomes greater than a lower bound voltage Vref. The lower bound voltage Vref is employed to avoid the switches Q1 to Q4 from concurrently being turned on, which may cause the issue of short through.

Accordingly, the full-wave rectifying circuit 122, shown in FIG. 6, performs the passive rectifying operation to the AC input voltage Vin for at least one half-cycle of the AC input voltage Vin to generate the rectified voltage Vr, and then starts performing the active rectifying operation from performing the passive rectifying operation when the absolute value of the AC input voltage Vin is equal to the DC central voltage Vc. In this case, the full-wave rectifying circuit 122 can convert the AC input voltage Vin to the rectified voltage Vr by performing either the passive rectifying operation or the active rectifying operation.

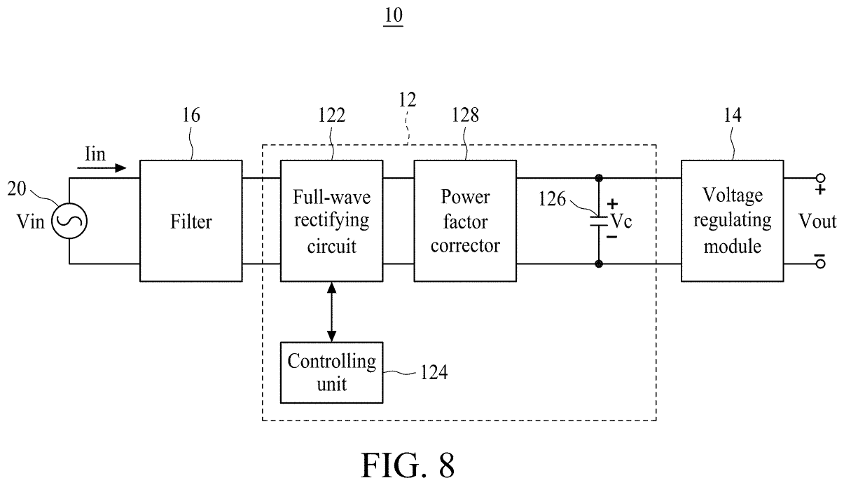

FIG. 8 is a circuit block diagram of a power supply apparatus 10 in accordance with some embodiments of the present disclosure. Referring to FIG. 8, the power supply apparatus 10 receives an alternating current (AC) input voltage Vin from an external source 20 and configured to convert the AC input voltage Vin to a direct current (DC) output voltage Vout, having a certain level. The power supply apparatus 10 includes a power conversion module 12, a voltage regulating module 14 and a filter 16. The filter 16 receives the AC input voltage Vin provided by the external source 20 through a live line L and a neutral line N and is adapted to suppress the noise, including electro-magnetic interference (EMI) in the AC input voltage Vin, thereby preventing the noise from reducing the performance of the power conversion module 12 and the voltage regulating module 14. The filter 16 would not change the form of the AC input voltage Vin. In some embodiments, the filter 16 may be further employed to prevent the high-frequency signals generated during the operation of the power supply apparatus 10 from affecting the AC input voltage Vin (such as AC mains).

The power conversion module 12 is electrically coupled to the filter 16; the power conversion module 12 receives the AC input voltage Vin through the filter 16 and is configured to convert the AC input voltage Vin to a DC central voltage Vc. The voltage regulating module 14 is electrically coupled to the power conversion module 12 and configured to regulate the magnitude of the DC central voltage Vc for generating the DC output voltage Vout.

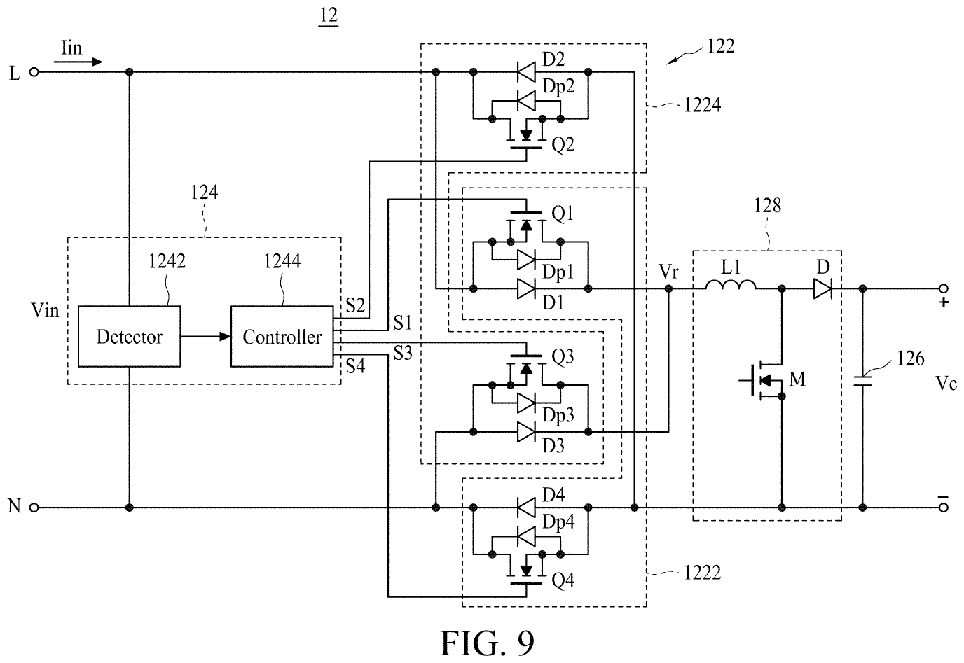

FIG. 9 is a circuit block diagram of power conversion module in accordance with some embodiments of the present disclosure. Referring to FIGS. 8 and 9, the power conversion module 12 includes a full-wave rectifying circuit 122, a controlling unit 124, a bulk capacitor 126 and a power factor corrector 128. The full-wave rectifying circuit 122 is arranged between the external source 20 and the bulk capacitor 126 and adapted to perform a passive rectifying operation or an active rectifying operation for converting the AC input voltage Vin to a rectified voltage Vr. The power factor corrector 128 receives the rectified voltage Vr and is employed to eliminate or reduce the phase difference between the rectified voltage Vr and the current created accordingly. The bulk capacitor 126 is employed to alternatively being charged and discharged accordingly to smooth the rectified voltage Vr, thereby outputting the DC central voltage Vc.

The full-wave rectifying circuit 122 includes a first diode D1, a second diode D2, a third diode D3, a fourth diode D4, a first switch Q1, a second switch Q2, a third switch Q3, and a fourth switch Q4. The first switch Q1, the fourth switch Q4, the first diode D1 and the fourth diode D4 constitute a first switching circuit 1222, and the second switch Q2, the third switch Q3, the second diode D2 and the third diode D3 constitute a second switching circuit 1224.

Specifically, the anode of the first diode D1 and the cathode of the second diode D2 are electrically coupled to the live line L, and the cathode of the first diode D1 is electrically coupled to the cathode of the third diode D3. In addition, the anode of the third diode D3 and the cathode of the fourth diode D4 are electrically coupled to the neutral line N, and the anode of the fourth diode D4 is electrically coupled to the anode of the second diode D2. The diodes DI to D4 can perform the passive rectifying operation during the initialization phase. That is, the diodes D1 to D4 are capable of performing the passive rectifying operation to convert the AC input voltage Vin to the rectified voltage Vr before the controlling unit 124 provides the electrical signals to the switches Q1 to Q4.

The switches Q1 to Q4 are the N-type enhancement MOSFETs. The source of the first switch Q1 and the drain of the second switch Q2 are electrically coupled to the live line L, the source of the third switch Q3 and the drain of the fourth switch Q4 are electrically coupled to the neutral line N, the drain of the first switch Q1 is electrically coupled to the drain of the third switch Q3, and the source of the second switch Q2 is electrically coupled to the source of the fourth switch Q4. The gates of the switches Q1 to Q4 are electrically coupled to the controlling unit 124, and the switches Q1 to Q4 can be turned on and turned off in accordance with the electrical signals generated by the controlling unit 124, thereby achieving the function of active rectification.

The first switch Q1 may have a parasitic diode Dp1; the anode of the parasitic diode Dp1 is electrically coupled to the source of the first switch Q1, and the cathode thereof is electrically coupled to the drain of the first switch Q1. The second switch Q2 may have a parasitic diode Dp2, the third switch Q3 may have a parasitic diode Dp3, and the fourth switch Q4 may have a parasitic diode Dp4. The anodes of the second to fourth parasitic diode Dp2 to Dp4 are electrically coupled to the respective sources of the second to fourth switch Q2 to Q4, and the cathodes of the second to fourth parasitic diode Dp2 to Dp4 are electrically coupled to the respective drains of the second to fourth switch Q2 to Q4. Typically, the forward voltages of the parasitic diodes Dp1 to Dp4 are greater than the forward voltages of the diodes D1 to D4; as such, when the power supply apparatus 10 is activated and before the controlling unit 124 begins to provide the electrical signals to the switches Q1 to Q4, the full-wave rectifying circuit 122 would mainly use the diodes D1 to D4 to perform the passive rectifying operation.

The power supply apparatus 10 is operable in a general phase and an initialization phase. In the present disclosure, the phase in which the power supply apparatus 10 is in the active state and the power factor corrector 128 can successfully carry out the power factor correction function is called the general phase, while the phase in which the power supply apparatus 10 is in the active state and the function of power factor correction has not been yet carried out by the power factor corrector 128 is called the initialization phase. In the initialization phase, the diodes D1 to D4 in the full-wave rectifying circuit 122 are capable of performing the passive rectifying operation to convert the AC input voltage Vin to the rectified voltage Vr before the controlling unit 124 provides the electrical signals to the switches Q1 to Q4.

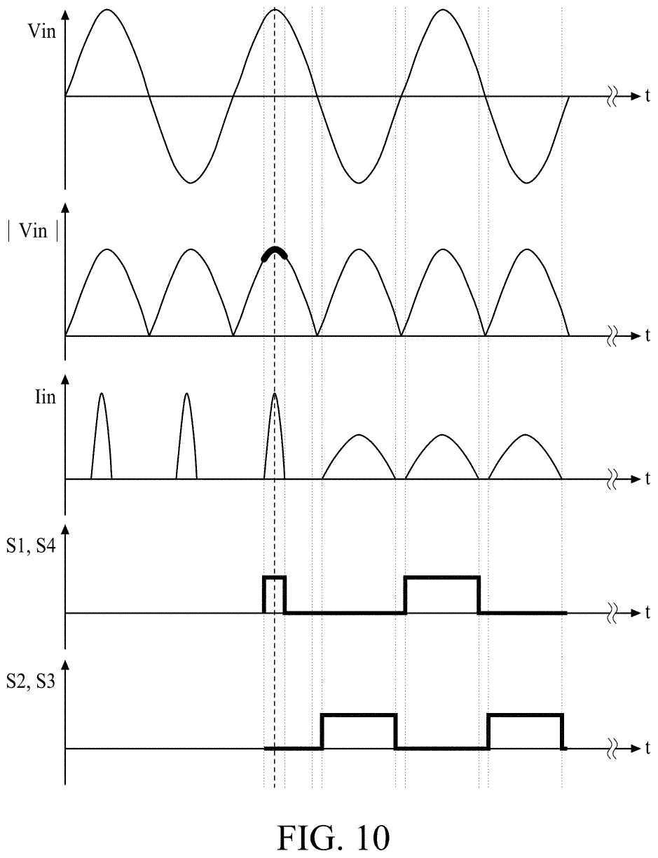

After the power supply apparatus 10 enters the active state from the inactive state and the response time of the controlling unit 124 has elapsed, the controlling unit 124 controls the first switching circuit 1222 or the second switching circuit 1224 to switch from performing the passive rectifying operation to performing the active rectifying operation when the AC input voltage Vin approaches a first preset phase (as the bold line segment at the waveform |Vin| illustrated in FIG. 10). In the present embodiment, the AC input voltage Vin has a sinusoidal waveform, and the first preset phase is represented by:

$$( \frac{1}{2} + m ) π$$

where m is an integer.

Also, in the present disclosure, approaching the first preset phase means the phase difference with the first preset phase is not greater than 5 degrees (i.e., π/36). For example, in FIG. 10, the full-wave rectifying circuit 122 performs the passive rectifying operation at the first and second half-cycles of the AC input voltage Vin, and transfers from performing the passive rectifying operation to performing the active rectifying operation at the third half-cycles of the AC input voltage Vin. Therefore, when the phase of the AC input voltage Vin is not smaller than the 85 degrees and not greater than 95 degrees, the controller 1244 is configured to generate the electrical signals S1 and S4 with the logic high level to the first switch Q1 and the fourth switch Q4, and generate the electrical signals S2 and S3 with the logic low level to the second switch Q2 and the third switch Q3. If the full-wave rectifying circuit 122 switches from performing passive rectification to performing active rectification during the fourth half cycle of the AC input voltage Vin, the controller 1244 will generate the electrical signals S1 and S4 with the logic low level to the first switch Q1 and the fourth switch Q4, and generate the electrical signals S2 and S3 with the high logic level to the second switch Q2 and the third switch Q3 when the phase of the AC input voltage Vim is not less than 265 degrees and not greater than 275 degrees.

During the general stage, the controlling unit 124 is further configured to control the first switching circuit 1222 or the second switching circuit 1224 to perform the active rectifying operation for converting the AC input voltage Vin to the rectified voltage Vr as the AC input voltage Vin is in a first phase range, wherein a center of the first phase range is the first preset phase. The first phase range is less than 180 degrees to avoid the switches Q1 to Q4 from concurrently turning on, causes the issue of short through. In detail, at the positive half-cycles of the AC input voltage Vin, the controlling unit 124 is configured to provide the electrical signals with the logic high level to the first switch Q1 and the fourth switch Q4 in the first switching circuit 1222 for turning on the first switch Q1 and the fourth switch Q4, and at the negative half-cycles of the AC input voltage Vin, the controlling unit 124 is configured to provide the electrical signals with the logic high level to the second switch Q2 and the third switch Q3 in the second switching circuit 1224 for turning on the second switch Q2 and the third switch Q3.

For example, at the positive half-cycles of the AC input voltage Vin, the controlling unit 124 turns on the first switch Q1 and the fourth switch Q4 when the AC input voltage Vin is not less than 5 degrees and not greater than 175 degrees. At the negative half-cycles of the AC input voltage Vin, the controlling unit 124 turns on the second switch Q2 and the third switch Q3 when the AC input voltage Vin is not less than 185 degrees and not greater than 355 degrees. In addition, at the positive half-cycles of the AC input voltage Vin, the controlling unit 124 turns off the first switch Q1 and the fourth switch Q4 when the AC input voltage Vin is not less than 0 degrees and less than 5 degrees and when the AC input voltage Vin is greater than 175 degrees and not greater than 180 degrees. At the negative half-cycles of the AC input voltage Vin, the controlling unit 124 turns off the second switch Q2 and the third switch Q3 when the AC input voltage Vin is not less than 180 degrees and less than 185 degrees and when the AC input voltage Vin is greater than 355 degrees and not greater than 360 degrees to prevent the issue of short through. That is, the controlling unit 124 is configured to control the first switching circuit 1222 or second switching circuit 1224 to stop performing the active rectifying operation in a second phase range centered at a second preset phase of the AC input voltage Vin. Wherein the second phase range is less than the first phase range, and the second phase range is represented by:
nπ,

where n is the integer.

In order to effectively determine whether the AC input voltage Vin has reached or exceeded the preset phase, the controlling unit 124 may include the detector 1242 for monitoring the instantaneous phase of the AC input voltage Vin. The controlling unit 124 further includes a controller 1244 electrically coupled to the detector 1242; the controller 1244 generates the electrical signals S1 to S4 for turning on and off the switches Q1 to Q4 based on the monitoring result of the detector 1242, thereby allowing the full-wave rectifying circuit 122 to function smoothly.

When the power supply apparatus 10 is operated in the general phase at the positive half-cycle of the AC input voltage Vin, if the drain-source voltages of the first switch Q1 and the fourth switch Q4 in the actuated first switching circuit 1222 are equal to or greater than the threshold voltages of the first diode D1 and the fourth diode D4, the first switch Q1, the fourth switch Q4, the first diode D1, and fourth diode D4 would be turned on simultaneously. Similarly, when the power supply apparatus 10 is operated in the general phase at the negative half-cycle of the AC input voltage Vin, if the drain-source voltages of the second switch Q2 and the third switch Q3 in the actuated second switching circuit 1224 are equal to or greater than the threshold voltages of the second diode D2 and the third diode D3, the second switch Q2, the third switch Q3, the second diode D2, and the third diode D3 would be turned on simultaneously.

Referring again to FIG. 4, when the forward current remains constant, the forward voltage of the diode at an ambient temperature of 25° C. is greater than the forward voltage thereof at an ambient temperature of 150° C.; that is, the forward voltage of the diode has a negative temperature coefficient. Referring again to FIG. 5, when the forward current is a constant, the forward voltage of the semiconductor switch at an ambient temperature of 25° C. is smaller than the forward voltage thereof at an ambient temperature of 125° C.; that is, the forward voltage of the semiconductor switch has a positive temperature coefficient. Therefore, when the forward current is a constant, the loss of the diode operated in a high temperature environment is less than the loss thereof in a low temperature environment. In addition, the loss of a semiconductor switch in the high temperature environment is greater than the loss thereof in the low temperature environment. Generally, the operation temperature of the power supply apparatus 10 tends to increase with increasing input current Iin. Thus, when the power switch (or called the semiconductor switch) is electrically coupled to the diode in parallel, a percentage of the power conduction loss of the switches Q1 to Q4 in a small current operation is smaller than a percentage of the power conduction loss of the switches Q1 to Q4 in a high current operation. Therefore, the function of active rectification carried out by the full-wave rectifying circuit 122, including the semiconductor switches and the diodes, can prevent the power loss from increasing rapidly when the power supply apparatus 10 is operated under different input currents Iin. That is, the full-wave rectifying circuit 122, including the switches Q1 to Q4 and the diodes DI to D4, can prevent the power loss from increasing rapidly when the power supply apparatus 10 enters a high power operation. The power conversion module 12 shown in FIG. 6 may also further include the diodes DI to D4 shown in FIG. 9 to reduce the variation of the power loss during the transition between the medium power mode and high power mode.

In summary, the full-wave rectifying circuit 122 shown in FIG. 9 performs a passive rectification operation for at least one half cycle of the AC input voltage Vin when the power supply apparatus 10 is in the initialization phase. When the AC input voltage Vin reaches the first predetermined phase, the full-wave rectifying circuit 122 is switched from the passive rectifying operation to the active rectifying operation; in such manner, the full-wave rectifying circuit 122 can be effectively prevented from being switched from the passive rectifying operation to the active rectifying operation at the wrong time point and so as to prevent the malfunction of the power supply apparatus 10.

Notably, in some embodiments, the detector 1242 in the controlling unit 124 can be configured to detect the instantaneous level and instantaneous phase of the AC input voltage Vin at the same time, and the controller 1244 can be configured to determine the phase and the level of the AC input voltage Vim at the same time. In such embodiments, the controlling unit 124 preferentially uses the instantaneous phase of the AC input voltage Vin as the basis for switching the full-wave rectifying circuit 122 from the passive rectifying operation to active rectifying operation. If the controlling unit 124 cannot successfully obtain the instantaneous phase of the AC input voltage Vin, the controlling unit 124 controls the full-wave rectifying circuit 122 to switch from the passive rectifying operation to the active rectifying operation based on the instantaneous level of the AC input voltage Vin.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. A power supply apparatus, for operating in an initialization stage and a general stage, comprising:
a full-wave rectifying circuit comprising a first switching circuit and a second switching circuit, wherein the full-wave rectifying circuit is configured to receive an alternating current (AC) input voltage through a live line and a neutral line and convert the AC input voltage to a rectified voltage; and
a controller coupled to the full-wave rectifying circuit and configured to control the first switching circuit or the second switching circuit to perform an active rectifying operation as an absolute value of the AC input voltage is greater than a lower bound voltage during the general stage,
wherein during the initialization stage, the full-wave rectifying circuit performs a passive rectifying operation for at least a first half-cycle of the AC input voltage, and the controller is configured to control the first switching circuit or the second switching circuit to switch from performing the passive rectifying operation to performing the active rectifying operation as the absolute value of the AC input voltage upwardly reaches or exceeds an upper bound voltage, wherein the upper bound voltage is greater than the lower bound voltage.

2. The power supply apparatus of claim 1, wherein during the initialization stage, the controller is configured to control the first switching circuit or the second switching circuit to perform the active rectifying operation when the absolute value of the AC input voltage is greater than the lower bound voltage.

3. The power supply apparatus of claim 2, wherein the controller is configured to control the first switching circuit or the second switching circuit to stop performing the active rectifying operation when the absolute value of the AC input voltage is not greater than the lower bound voltage.

4. The power supply apparatus of claim 1, wherein the upper bound voltage is a peak voltage of the rectified voltage.

5. The power supply apparatus of claim 1, wherein:
the full-wave rectifying circuit comprises a first switch, a second switch, a third switch, and a fourth switch;
the first switch and second switch are coupled to the live line;
the third switch is coupled to the first switch and the neutral line;
the fourth switch is coupled to the second switch, the third switch and the neutral line;
the first switch and fourth switch constitute the first switching circuit;
the second switch and third switch constitutes the second switching circuit; and
the first switch, the second switch, the third switch and the fourth switch are coupled to the controller, respectively.

6. The power supply apparatus of claim 5, wherein the first switch, the second switch, the third switch and the fourth switch have respective parasitic diode for passively rectifying the AC input voltage and output the rectified voltage.

7. The power supply apparatus of claim 6, wherein the full-wave rectifying circuit further comprising:
a first diode electrically coupled to the first switch in parallel;
a second diode electrically coupled to the second switch in parallel;
a third diode electrically coupled to the third switch in parallel; and
a fourth diode electrically coupled to the fourth switch in parallel.

8. The power supply apparatus of claim 5, wherein the controller is configured to control the first switching circuit to perform the active rectifying operation at a positive half-cycle of the AC input voltage, and is configured to control the second switching circuit to perform the active rectifying operation at a negative half-cycle of the AC input voltage.

9. A power supply apparatus, for operating in an initialization stage and a general stage, comprising:
a full-wave rectifying circuit comprising a first switching circuit and a second switching circuit, wherein the full-wave rectifying circuit is configured to receive an AC input voltage through a live line and a neutral line, and convert the AC input voltage to a rectified voltage; and
a controller coupled to the full-wave rectifying circuit, and configured to control the first switching circuit or the second switching circuit to perform an active rectifying operation during the general stage,
wherein during the initialization stage, the full-wave rectifying circuit performs a passive rectifying operation for at least a first half-cycle of the AC input voltage, the controller is configured to control the first switching circuit or the second switching circuit to switch from performing the passive rectifying operation to performing the active rectifying operation as the AC input voltage approaches a first preset phase, the AC input voltage has a sinusoidal waveform, and the first preset phase is represented by:
$$( \frac{1}{2} + m ) π ,$$
where m is an integer.

10. The power supply apparatus of claim 9, wherein during the general stage, the controller is configured to control the first switching circuit or the second switching circuit to perform the active rectifying operation as the AC input voltage is in a first phase range, a center of the first phase range is the first preset phase, and the first phase range is less than 180 degrees.

11. The power supply apparatus of claim 10, wherein the controller is configured to control the first switching circuit or the second switching circuit to stop performing the active rectifying operation as the AC input voltage is in a second phase range, a center of the second phase range is the second preset phase, and the second phase range is less than the first phase range, and the second preset phase is represented by:
nπ,
where n is an integer.

12. The power supply apparatus of claim 9, wherein:
the full-wave rectifying circuit comprises a first switch, a second switch, a third switch, and a fourth switch;
the first switch and second switch are coupled to the live line;
the third switch is coupled to the first switch and the neutral line;
the fourth switch is coupled to the second switch, the third switch and the neutral line;
the first switch and fourth switch constitute the first switching circuit;
the second switch and third switch constitutes the second switching circuit; and
the first switch, the second switch, the third switch, and the fourth switch are coupled to the controller respectively.

13. The power supply apparatus of claim 12, wherein the first switch, the second switch, the third switch, and the fourth switch have respective parasitic diode for passively rectifying the AC input voltage and output the rectified voltage.

14. The power supply apparatus of claim 13, wherein the full-wave rectifying circuit further comprising:
a first diode electrically coupled to the first switch in parallel;
a second diode electrically coupled to the second switch in parallel;
a third diode electrically coupled to the third switch in parallel; and
a fourth diode electrically coupled to the fourth switch in parallel.

15. The power supply apparatus of claim 12, wherein the controller is configured to control the first switching circuit to perform the active rectifying operation at a positive half-cycle of the AC input voltage, and is configured to control the second switching circuit to perform the active rectifying operation at a negative half-cycle of the AC input voltage.

16. A voltage converting method, comprising:
performing, by a full-wave rectifying circuit, a passive rectifying operation to an AC input voltage for at least a first half-cycle of the AC input voltage to generate a rectified voltage; and
controlling the full-wave rectifying circuit to enter an active rectifying operation from the passive rectifying operation when an absolute value of the AC input voltage reaches or exceeds an upper bound voltage upwardly.

17. The method of claim 16, further comprising controlling the full-wave rectifying circuit to stop performing the active rectifying operation when the absolute value of the AC input voltage is not greater than a lower bound voltage.

18. The method of claim 17, further comprising controlling the full-wave rectifying circuit to perform the active rectifying operation when the absolute value of the AC input voltage is greater than the lower bound voltage.

19. The method of claim 16, wherein the upper bound voltage is a peak voltage of the rectified voltage.

20. A voltage converting method, comprising:
performing, by a full-wave rectifying circuit, a passive rectifying operation to an AC input voltage for at least a first half-cycle of the AC input voltage to generate a rectified voltage; and
controlling the full-wave rectifying circuit to enter an active rectifying operation from the passive rectifying operation as the AC input voltage approaches a first preset phase, wherein the AC input voltage has a sinusoidal waveform, and the first preset phase is represented by:
$$( \frac{1}{2} + m ) π ,$$
where m is an integer.

21. The method of claim 20, wherein controlling the full-wave rectifying circuit to perform the active rectifying operation as the AC input voltage is equal to the first preset phase and smaller than a terminating phase, wherein a phase difference between the first preset phase and the terminating phase is smaller than 90 degrees.
